(19) United States
(12) Patent Application Publication
(10) Pub. No.: US 2003/0151989 A1
(43) Pub. Date: Aug. 14, 2003

(54) Optical information processing apparatus incorporating diffraction grating with non-grating light receiving area

(75) Inventors: Koichi Tezuka, Kawasaki-shi (JP); Kyoko Tadaki, Kawasaki-shi (JP)

Correspondence Address: Patrick G. Burns, Esq., GREER, BURNS & CRAIN, LTD., 300 South Wacker Dr., Suite 2500, Chicago, IL, 60606, US

(73) Assignee: FUJITSU LIMITED

(21) Appl. No.: 10/280,727

(22) Filed: Oct. 25, 2002

(30) Foreign Application Priority Data
Feb. 8, 2002 (JP) 2002-033102

(51) Int. Cl. G11B 7/095

(52) U.S. Cl. 369/44.37

(57) ABSTRACT

An optical information processing apparatus is designed to generate a tracking error signal based on reflected light from a storage medium. The apparatus is a 3-beam type, in which the storage medium is irradiated by a main beam and two sub-beams offset from the main beam in the tracking direction of the storage medium. Each of the two sub-beams is, as viewed on the storage medium, smaller in size in the tracking direction than the main beam.

### BACKGROUND OF THE INVENTION

1. Field of the Invention

The present invention relates to an optical information processing apparatus such as an optical disk device and a magneto-optical disk device. In particular, the present invention relates to an optical information processing apparatus of the type utilizing three light beams for performing tracking control.

2. Description of the Related Art

As conventionally known, tracking control is performed in an optical disk apparatus so that the beam spot for data-recoding or data-reproducing is formed precisely on the target track of an optical data-storage disk. Typically, tracking control can be performed by two different ways, i.e. push-pull method and 3-beam method. In the push-pull method, tracking error signals are produced by utilizing diffracted beams to be contained in the reflection light from the optical disk. The push-pull method, however, is disadvantageous in that the center of the beam spot is likely to deviate from the target track when the eccentricity of the optical disk is great. The 3-beam method, on the other hand, does not suffer such a drawback.

FIG. 6 of the accompanying drawings shows the principal components of a conventional optical disk apparatus of the 3-beam type. In the apparatus, the laser beams emitted from a light source 90 are made parallel as they pass through a collimator lens 91. Thereafter, the collimated light passes through a beam splitter 92, a transmission type diffraction grating 93 and an objective lens 94, and then strikes on the disk D. As shown in FIG. 7, the diffraction grating 93 is formed with a great number of fine grooves 93a on one side. When a laser beam passes through the grating 93 with such grooves, the light is split into a main beam 8 (resulting from 0-order diffraction) and sub-beams 8a, 8b (resulting from plus/minus 1-order diffraction). As shown in FIG. 8, these split beams produce three light spots on the disk D. The sub-beams 8a, 8b are offset oppositely from the main beam 8 in the tracking direction Tg (perpendicular to the track direction Tc) by a distance L1.

In the above arrangements, when the main beam 8 is properly focused on the target track T (cross-hatched in FIG. 8), the amounts of the reflected light resulting from the sub-beams 8a, 8b are equal. However, when the main beam 8 deviates inward of the disk D (downward in FIG. 8) from the target track T, the sub-beam 8a mostly irradiates an adjacent land L, while the other sub-beam 8b is focused onto the target track T, as shown in FIG. 9A. Accordingly, the amount of the reflected light due to the sub-beam 8a becomes less than that of the reflected light due to the sub-beam 8b. On the other hand, when the main beam 8 deviates outward of the disk D (upward in FIG. 8) from the target track T, the sub-beam 8b mostly irradiates the other adjacent land L, while the other sub-beam 8a is focused onto the target track T, as shown in FIG. 9B. Accordingly, the amount of the reflected light due to the sub-beam 8b becomes less than that of the reflected light due to the sub-beam 8a. Based on these differences in reflected light, it is possible to detect the direction and degree of the tracking error. Referring to FIG. 6, after the main beam 8 and sub-beams 8a-8b are reflected by the disk D, the course of the reflected beams is changed by the beam splitter 92, so that the beams are led to a certain detecting system via appropriate optical devices. Though not shown in the drawings, the detecting system includes a tracking error detector to produce tracking error signals based on the difference in reflection between the sub-beams 8a and 8b.

The main beam 8, used for reading and writing data, has greater intensity than the sub-beams 8a, 8b. As seen from FIG. 8, all the light spots formed by the beams 8 and 8a-8b are circular and equal in diameter.

FIGS. 10A and 10B illustrate the profiles of the conventional main beam and hence sub-beams for the track direction (FIG. 10A) and the tracking direction (FIG. 10B). In the illustrated instance, the light source is a semiconductor laser whose wavelength is 405 nm, and the objective lens has a numerical aperture of 0.9. The 1/e²-beam diameters of the profiles are 0.41 μm for both the track direction and the tracking direction.

The conventional technique, where the light spots of the main beam 8 and sub-beams 8a-8b are made equal, suffers the following drawback.

In the field of optical disk apparatus, there is increasing demand for much higher data-recording density. To achieve a higher data-recording density, it is necessary to reduce the track pitch of the optical disk. While the track pitch should be small for high density, the light spot of the main beam 8 needs to be larger than a certain limit to perform proper data-writing to the tracks of the disk. Accordingly, in the conventional disk apparatus, the light spots of the sub-beams 8a-8b are also made large after the designs of the main beam 8.

Unfavorably, there is a disadvantage in the above-described equal-diameter design for the main and sub-beams. Referring to FIG. 11, when the track pitch t is reduced, both the sub-beams 8a, 8b can overlap two tracks T while irradiating the narrowed land L between the neighboring tracks. Under this condition, even when the main beam 8 considerably deviates from the target track T, the two sub-beams 8a, 8b may only produce a small difference in amount of their reflected light. This implies lowered sensitivity for the tracking error.

In the instance noted above with reference to FIGS. 10A and 10B, the beam diameter (1/e²) of the beam profile is 0.41 μm for the track direction and the tracking direction. Under the same conditions, when the track pitch t is reduced from 0.32 μm to 0.25 μm, for example, the tracking error sensitivity will deteriorate to about 13% of that for the 0.32 μm-case. With such reduced sensitivity, it is difficult or even impossible to perform reliable tracking control.

### SUMMARY OF THE INVENTION

The present invention has been proposed under these circumstances. It is, therefore, an object of the present invention to provide an optical information processing apparatus of the 3-beam type with which reliable tracking control can be performed without suffering the deterioration of tracking error sensitivity even when the track pitch of the storage disk is reduced.

According to the present invention, there is provided an optical information processing apparatus designed to generate a tracking error signal based on reflected light from a storage medium. The apparatus is provided with a main beam that irradiate the storage medium and two sub-beams that irradiate the storage medium and are offset from the main beam in a tracking direction. Each of the two sub-beams is, as viewed on the storage medium, smaller in size in the tracking direction than the main beam.

Preferably, the apparatus may further include: a light source; an objective lens for focusing light emitted from the light source onto the storage medium; and a diffraction grating provided with a light receiving region for receiving the light emitted from the light source. The diffraction grating is designed to split the emitted light into the main beam and the two sub-beams. To this end, the light receiving region of the diffraction grating is provided with a grating area and a non-grating area.

Preferably, the non-grating area, as viewed in the tracking direction, may be arranged at a central portion of the light receiving region, and have a rectangular configuration elongated in a track direction intersecting the tracking direction.

Preferably, the non-grating area may be arranged at a center of the light receiving region and have a circular configuration.

Preferably, the non-grating area, as viewed in the tracking direction, may be arranged at a central portion of the light receiving region, and have an elliptic configuration elongated in a track direction intersecting the tracking direction.

Other features and advantages of the present invention will become apparent from the detailed description given below with reference to the accompanying drawings.

### BRIEF DESCRIPTION OF THE DRAWINGS

FIG. 1 shows the principal components of an optical information processing apparatus embodying the present invention;

FIG. 2A is a front view showing a diffraction grating used for the apparatus of FIG. 1;

FIG. 2B is a side view showing the diffraction grating of FIG. 2A;

FIG. 2C is a sectional view showing the diffraction grating of FIG. 2A;

FIG. 3 shows the arrangement of the main beam and sub-beams on a storage medium;

FIGS. 4A and 4B show the profiles of the main beam in the track direction and tracking direction;

FIGS. 4C and 4D show the profiles of the sub-beam in the track direction and tracking direction;

FIGS. 5A and 5B show examples of diffraction gratings used for the information processing apparatus of FIG. 1;

FIG. 6 shows the principal components of a conventional optical information processing apparatus;

FIG. 7 shows a conventional diffraction grating used for the apparatus of FIG. 6;

FIG. 8 shows the arrangement of the conventional main and sub-beams;

FIGS. 9A and 9B show the locations of the main and sub-beams relative to the storage medium when a tracking error occurs;

FIGS. 10A and 10B show the profiles of the conventional main and sub-beams in the track direction and tracking direction; and

FIG. 11 illustrates a problem of the prior art.

### DETAILED DESCRIPTION OF THE PREFERRED EMBODIMENTS

Preferred embodiments of the present invention will be described below with reference to the accompanying drawings.

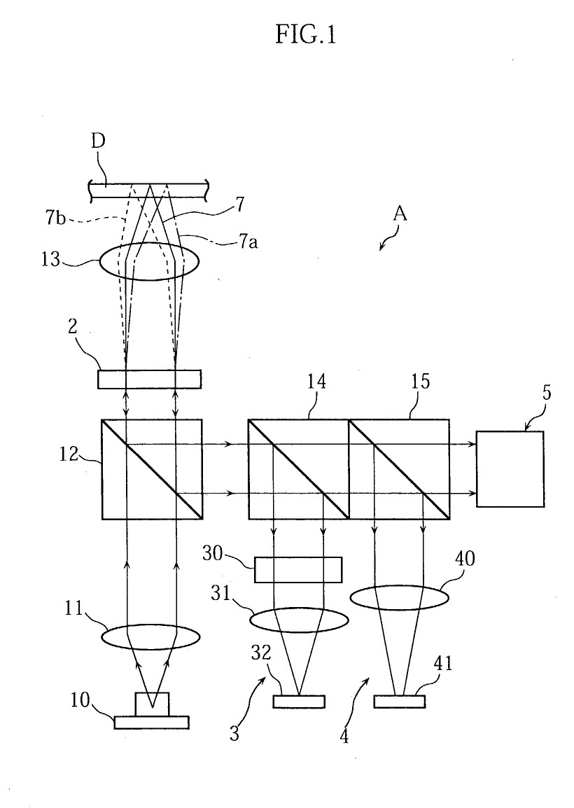

FIG. 1 shows the principal components of an optical disk apparatus A according to the present invention. The apparatus A includes a light source 10, a collimator lens 11, a first beam splitter 12, a diffraction grating 2 of a transmission type, and an objective lens 13. As shown in the figure, the light source 10 emits a laser beam toward an optical data-storage disk D. Specifically, the emitted laser beam from the light source 10 consecutively passes through the collimator lens 11 (to be collimated), the first beam splitter 12, the diffraction grating 2 and the objective lens 13. Then, the light reflected on the disk D will pass through the lens 13 and the grating 2 in the opposite direction, and reach the first beam splitter 12. Thereafter, the light is directed toward a second beam splitter 14 and a third beam splitter 15. In the second splitter 14, the light is partly directed toward an RF signal detecting unit 3 and partly allowed to travel toward the third splitter 15. Similarly, in the third splitter 15, the light is partly directed toward a tracking error detecting unit 4 and partly allowed to travel toward a focus error detecting unit 5.

Like the conventional diffraction grating 93, the grating 2 of the present invention splits the emitted light into a main beam 7 (0-order diffracted beam) and two sub-beams, i.e. first and second sub-beams 7a, 7b (+ and − 1-order diffracted beam). However, the structure and function of the grating 2 differ from those of the conventional grating 93 in the following respects.

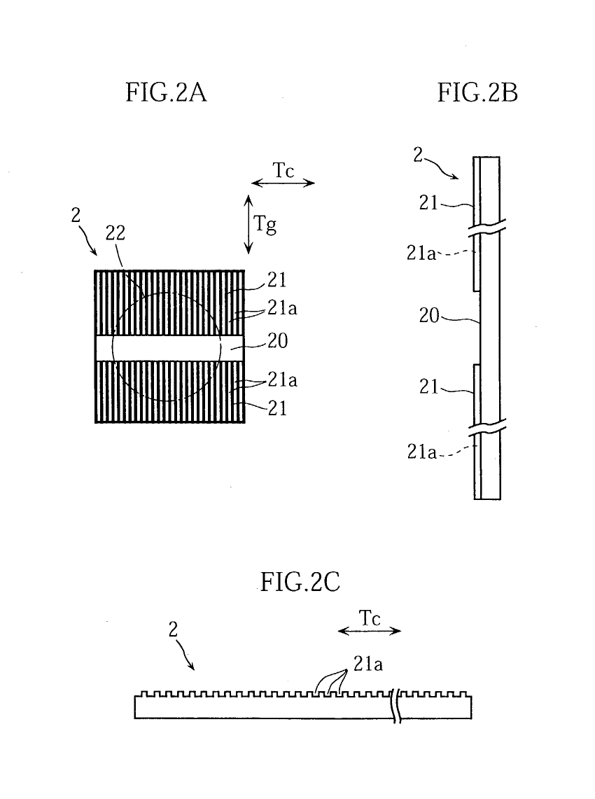

Referring to FIG. 2A, the grating 2 includes a front surface in which a circular light-receiving region 22 is provided for receiving the laser beam emitted from the light source 10. The front surface is also provided with a non-grating area 20 and a pair of grating areas 21 separated by the non-grating area 20. The non-grating area 20 is made flat so that the laser beam passing through it will not be diffracted. The non-grating area 20 extends in the track direction Tc, passing through the center of the light-receiving region 22. The grating areas 21 are formed with a great number of grooves 21a, each extending in the tracking direction Tg, for splitting the emitted laser beam into the main beam 7 and the two sub-beams 7a, 7b. The pitch between the adjacent grooves 21a may be 12 μm, and the depth of each groove 21a may be 140 nm. The grating 2 is so designed as to prevent or minimize the generation of unnecessary diffracted beams such as 2- or higher order diffracted beams. In this manner, it is possible to prevent the main beam 7 and the sub-beams 7a, 7b from being weakened by the high order diffracted beams.

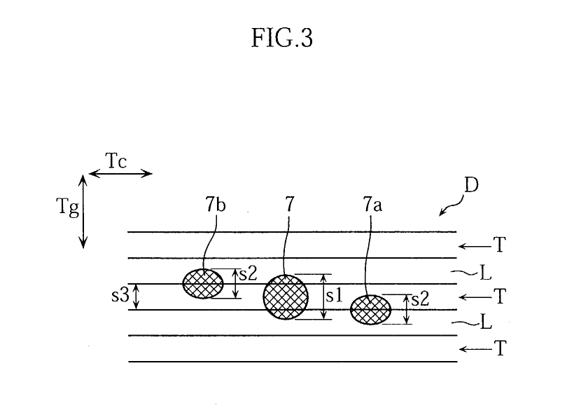

Referring to FIG. 3, the beam arrangement on the disk D is similar to the conventional arrangement shown in FIG. 8. Specifically, in the track direction Tc, the main beam 7 is located between the two sub-beams 7a and 7b. In the tracking direction Tg, the sub-beams 7a and 7b are oppositely offset from the main beam 7 by a predetermined distance. To perform proper data-writing, the intensity of the main beam 7 is set to be about eight times as strong as that of each sub-beam 7a, 7b. According to the illustrated embodiment, the light spot resulting from the main beam 7 is circular, whereas the light spot resulting from each sub-beam 7a, 7b has an elliptic shape, elongated in the track direction Tc. As seen from FIG. 3, the elliptic light spot of the sub-beam 7a, 7b has a width s2 which is smaller than the diameter s1 of the circular spot of the main beam 7. This elliptic form results from the effect of the non-grating area 20 provided in the light receiving region 22 of the grating 2. Specifically, the presence of the non-grating area 20 prevents the generation of certain types of diffracted rays which would be produced with the use of the conventional grating 93. As a result, the cross-sectional shape of the sub-beams 7a, 7b is not circular but elliptic.

Referring back to FIG. 1, after the main beam 7 and the sub-beams 7a, 7b are reflected on the disk D, they will pass through the diffraction grating 2 to be subjected to further splitting by 0-order diffraction and (±) 1-order diffraction. In this case, however, the resulting 1-order diffracted beams are negligibly weak. Thus, consideration should be made only to the 0-order diffraction of the main beam 7 and the sub-beams 7a, 7b.

The RF signal detecting unit 3 is provided with a Wollaston prism 30, a focusing lens 31 and an optical detector 32. In the unit 3, the Wollaston prism 30 splits light (the main beam 7, precisely) from the second beam splitter 14 into P wave and S wave. Then, the split waves are focused by the lens 31 onto the detector 32 which outputs a signal corresponding to the received P waves and a signal corresponding to the received S waves. Based on the difference between these two kinds of signals, a required data signal is produced.

The tracking error detecting unit 4 is provided with a focusing lens 40 and an optical detector 41. In the unit 4, light (the sub-beams 7a and 7b, precisely) from the third beam splitter 15 is focused by the lens 40 onto the detector 41 which outputs a signal corresponding to the sub-beam 7a and a signal corresponding to the sub-beam 7b. Based on the difference between these two kinds of signals, a tracking error signal is produced. The out-of-track direction and degree are known from the tracking error signal (i.e. the difference between the sub-beams 7a and 7b).

The focus error detecting unit 5 produces a focus error signal based on the light that has passed through the third beam splitter 15. For this signal production, use may be made of a known astigmatism or Foucault method, which does not rely on the sub-beams 7a, 7b.

In the optical disk apparatus A, as noted above with reference to FIG. 3, the light spots of the sub-beams 7a, 7b have a smaller width s2 (the size in the tracking direction Tg) than the main beam 7 having a diameter of s1. Therefore, even when the track pitch t is reduced, the light spot of each sub-beam 7a, 7b does not overlap more than one track T with an unduly large shared area. With this arrangement, it is easier than with the conventional apparatus to distinguish between the amounts of reflected light with respect to the two sub-beams 7a, 7b when a tracking error occurs. Advantageously, this contributes to preventing the tracking error detecting unit 4 from suffering the lowering of the tracking error sensitivity.

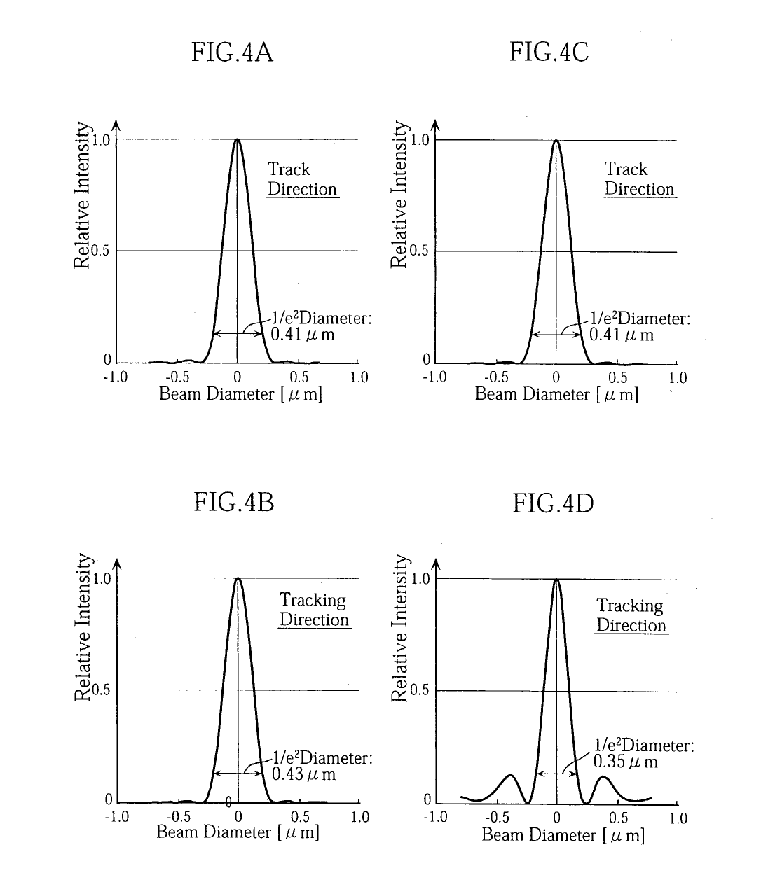

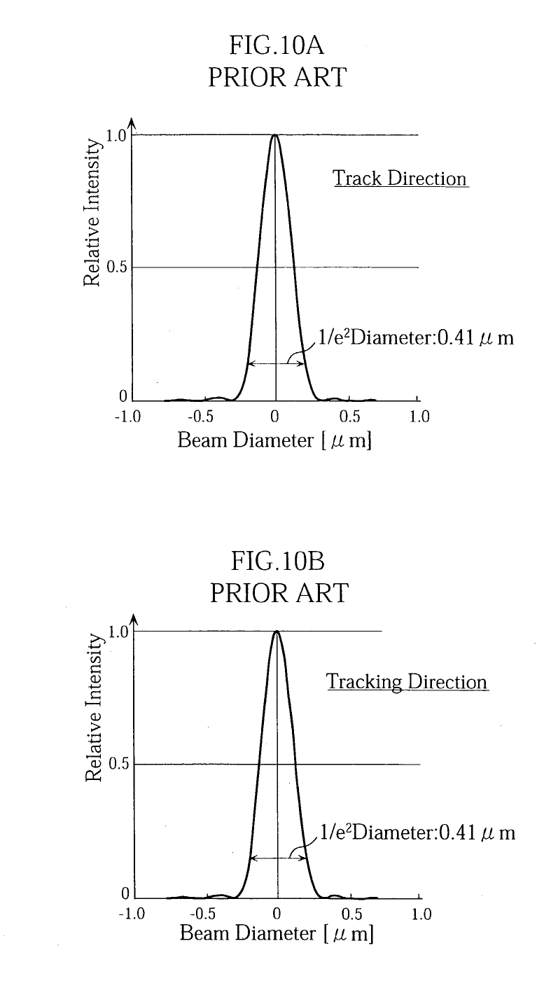

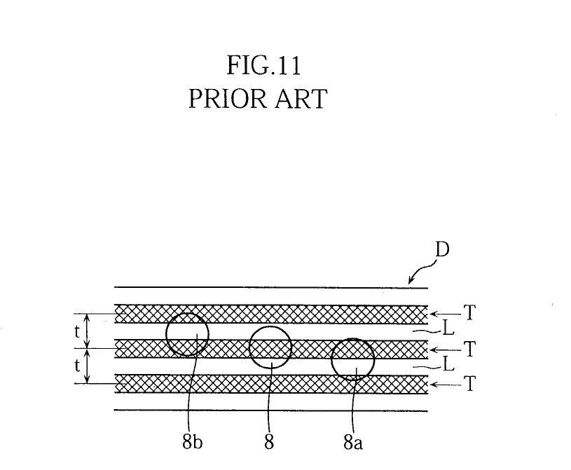

FIGS. 4A-4D illustrate the beam profiles on the disk D for the main beam 7 and the sub-beams 7a, 7b of the apparatus A. These profiles were obtained under the same conditions as the conventional beam profiles of FIGS. 10A-10B were obtained, except that the grating 2 was used in place of the grating 93. In the grating 2, as noted above, the two grating areas 21 (see FIG. 2A) are separated from each other by the non-grating area 20. The separation distance (i.e. the width of the non-grating area 20) was made about 15% of the diameter of the light receiving region 22.

FIG. 4D shows the tracking-direction profile of the sub-beams 7a, 7b. The illustrated profile shows that the 1/e²-beam diameter is 0.35 μm (note that the two small lobes flanking the main projection are negligible). This value is smaller than the 1/e²-beam diameter of the main beam 7 as viewed in the track direction (FIG. 4A) and in the tracking direction (FIG. 4B), and also smaller than the 1/e²-beam diameter of the conventional sub-beams shown in FIGS. 10A and 10B. With the use of the sub-beams 7a, 7b having such an elliptic cross section, the tracking error detection sensitivity is maintained at a high level even when the tracking pitch t is reduced. Specifically, when the pitch t is reduced from 0.32 μm to 0.25 μm, the resulting tracking error detection sensitivity (i.e. for the pitch of 0.25 μm) is about 65% of the initial sensitivity (i.e. for the pitch of 0.32 μm). This is an advantageously great rate, as compared to the conventional counterpart number “13%”.

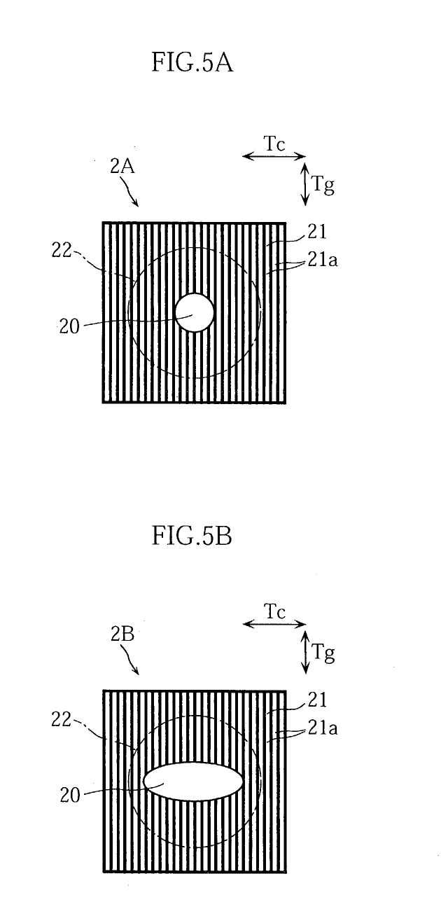

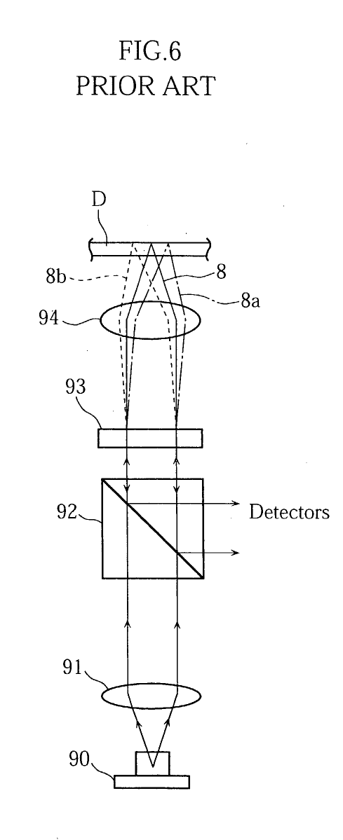

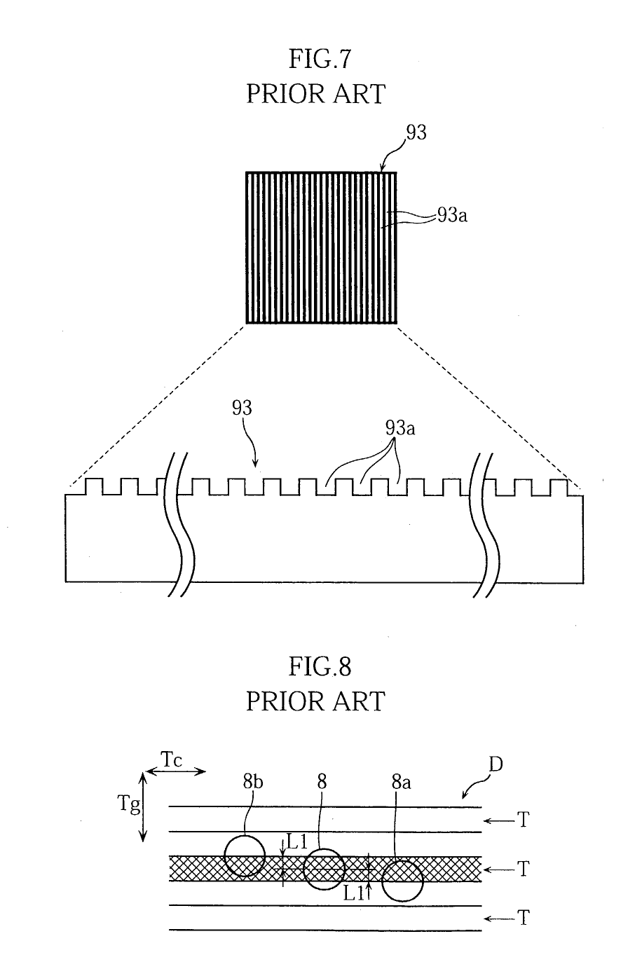

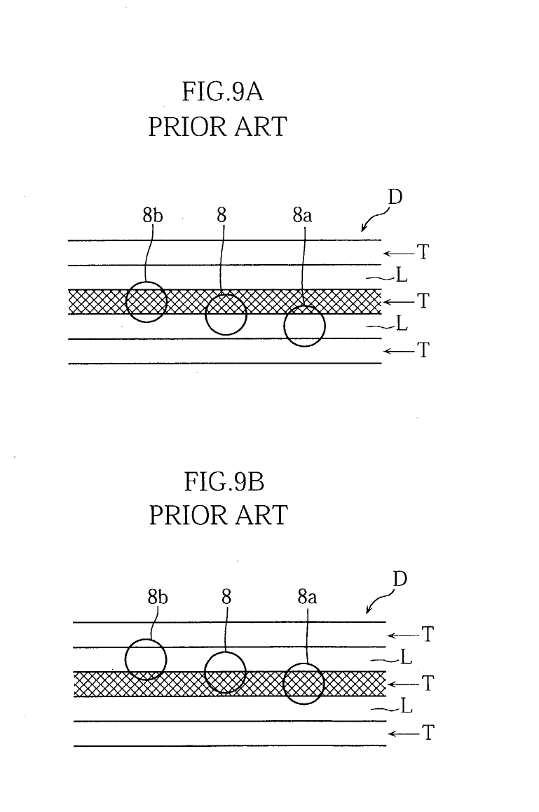

FIGS. 5A and 5B show other possible examples of diffraction gratings. Through these figures, the same reference signs are used to refer to elements identical or similar to those of the above-described diffraction grating 2. In the diffraction grating 2A shown in FIG. 5A, the non-grating area 20 is circular and concentric to the light receiving region 22. With this arrangement, the size of the sub-beams 7a, 7b is reduced both in the tracking direction and in the track direction, whereas the main beam 7 is elongated in the track direction.

In the diffraction grating 2B shown in FIG. 5B, the non-grating region 20 has an elliptic shape, elongated in the track direction Tc. With the use of the grating 2B again, the size of the sub-beams 7a, 7b is reduced in the tracking direction Tg. Like the grating 2A, the grating 2B elongates the main beam 7, but to a lesser extent.

The above-described specific features of the diffraction gratings are for illustration and not limitation.

In the above-described examples, a diffraction grating is provided with a non-grating region for reducing the size of a sub-beam in the tracing direction. To achieve this reduction, however, use may be made of a light-concentrating device separate from a diffraction grating.

The present invention being thus described, it is obvious that the same may be varied in many ways. Such variations are not to be regarded as a departure from the spirit and scope of the present invention, and all such modifications as would be obvious to those skilled in the art are intended to be included within the scope of the following claims.

1. An optical information processing apparatus designed to generate a tracking error signal based on reflected light from a storage medium, the apparatus comprising a main beam that irradiate the storage medium and two sub-beams that irradiate the storage medium and are offset from the main beam in a tracking direction,
wherein each of the two sub-beams is, as viewed on the storage medium, smaller in size in the tracking direction than the main beam.

2. The apparatus according to claim 1, further comprising: a light source; an objective lens for focusing light emitted from the light source onto the storage medium; and a diffraction grating provided with a light receiving region for receiving the light emitted from the light source, the diffraction grating designed to split the emitted light into the main beam and the two sub-beams;
wherein the light receiving region of the diffraction grating is provided with a grating area and a non-grating area.

3. The apparatus according to claim 2, wherein the non-grating area, as viewed in the tracking direction, is arranged at a central portion of the light receiving region, the non-grating area having a rectangular configuration elongated in a track direction intersecting the tracking direction.

4. The apparatus according to claim 2, wherein the non-grating area is arranged at a center of the light receiving region and has a circular configuration.

5. The apparatus according to claim 2, wherein the non-grating area, as viewed in the tracking direction, is arranged at a central portion of the light receiving region, the non-grating area having an elliptic configuration elongated in a track direction intersecting the tracking direction.
